(19) United States
(12) Patent Application Publication
(10) Pub. No.: US 2022/0279593 A1
(43) Pub. Date: Sep. 1, 2022

(54) RANDOM ACCESS RADIO NETWORK TEMPORARY IDENTIFIER FOR RANDOM ACCESS

(71) Applicant: QUALCOMM Incorporated, San Diego, CA (US)

(72) Inventors: Ruiming ZHENG, Beijing (CN); Linhai HE, San Diego, CA (US); Jing LEI, San Diego, CA (US)

(21) Appl. No.: 17/597,827

(22) PCT Filed: Aug. 16, 2019
(86) PCT No.: PCT/CN2019/100961

§ 371 Date: Jan. 25, 2022

(51) Int. Cl. H04W 74/08; H04W 72/04

(52) U.S. Cl. CPC H04W 74/0841; H04W 74/0866; H04W 72/0446

(57) ABSTRACT

Various aspects of the present disclosure generally relate to wireless communication. In some aspects, a user equipment may determine a random access radio network temporary identifier (RA-RNTI), associated with a random access channel (RACH) procedure, based at least in part on: a radio frame index associated with a RACH occasion in which a RACH preamble is transmitted during the RACH procedure, or a type of the RACH procedure; and receive a random access message based at least in part on the RA-RNTI. Numerous other aspects are provided.

### FIELD OF THE DISCLOSURE

Aspects of the present disclosure generally relate to wireless communication and to techniques and apparatuses for a random access radio network temporary identifier (RA-RNTI) for random access.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a UE, may include determining a random access radio network temporary identifier (RA-RNTI), associated with a random access channel (RACH) procedure, based at least in part on: a radio frame index associated with a RACH occasion in which a RACH preamble is transmitted during the RACH procedure, or a type of the RACH procedure; and receiving a random access message based at least in part on the RA-RNTI.

In some aspects, a UE for wireless communication may include memory and one or more processors operatively coupled to the memory. The memory and the one or more processors may be configured to determine a RA-RNTI, associated with a RACH procedure, based at least in part on: a radio frame index associated with a RACH occasion in which a RACH preamble is transmitted during the RACH procedure, or a type of the RACH procedure; and receive a random access message based at least in part on the RA-RNTI.

In some aspects, a non-transitory computer-readable medium may store one or more instructions for wireless communication. The one or more instructions, when executed by one or more processors of a UE, may cause the one or more processors to: determine a RA-RNTI, associated with a RACH procedure, based at least in part on: a radio frame index associated with a RACH occasion in which a RACH preamble is transmitted during the RACH procedure, or a type of the RACH procedure; and receive a random access message based at least in part on the RA-RNTI.

In some aspects, an apparatus for wireless communication may include means for determining a RA-RNTI, associated with a RACH procedure, based at least in part on: a radio frame index associated with a RACH occasion in which a RACH preamble is transmitted during the RACH procedure, or a type of the RACH procedure; and means for receiving a random access message based at least in part on the RA-RNTI.

In some aspects, a method of wireless communication, performed by a base station, may include determining a RA-RNTI, associated with a RACH procedure, based at least in part on: a radio frame index associated with a RACH occasion in which a RACH preamble is received during the RACH procedure, or a type of the RACH procedure; and transmitting a random access message based at least in part on the RA-RNTI.

In some aspects, a base station for wireless communication may include memory and one or more processors operatively coupled to the memory. The memory and the one or more processors may be configured to determine a RA-RNTI, associated with a RACH procedure, based at least in part on: a radio frame index associated with a RACH occasion in which a RACH preamble is received during the RACH procedure, or a type of the RACH procedure; and transmit a random access message based at least in part on the RA-RNTI.

In some aspects, a non-transitory computer-readable medium may store one or more instructions for wireless communication. The one or more instructions, when executed by one or more processors of a base station, may cause the one or more processors to: determine a RA-RNTI, associated with a RACH procedure, based at least in part on: a radio frame index associated with a RACH occasion in which a RACH preamble is received during the RACH procedure, or a type of the RACH procedure; and transmit a random access message based at least in part on the RA-RNTI.

In some aspects, an apparatus for wireless communication may include means for determining a RA-RNTI, associated with a RACH procedure, based at least in part on: a radio frame index associated with a RACH occasion in which a RACH preamble is received during the RACH procedure, or a type of the RACH procedure; and means for transmitting a random access message based at least in part on the RA-RNTI.

Aspects generally include a method, apparatus, system, computer program product, non-transitory computer-readable medium, user equipment, base station, wireless communication device, and/or processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a diagram illustrating an example associated with a random access radio network temporary identifier (RA-RNTI) for random access, in accordance with various aspects of the present disclosure.

FIG. 4 is a diagram illustrating an example process performed, for example, by a user equipment, in accordance with various aspects of the present disclosure.

FIG. 5 is a diagram illustrating an example process performed, for example, by a base station, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

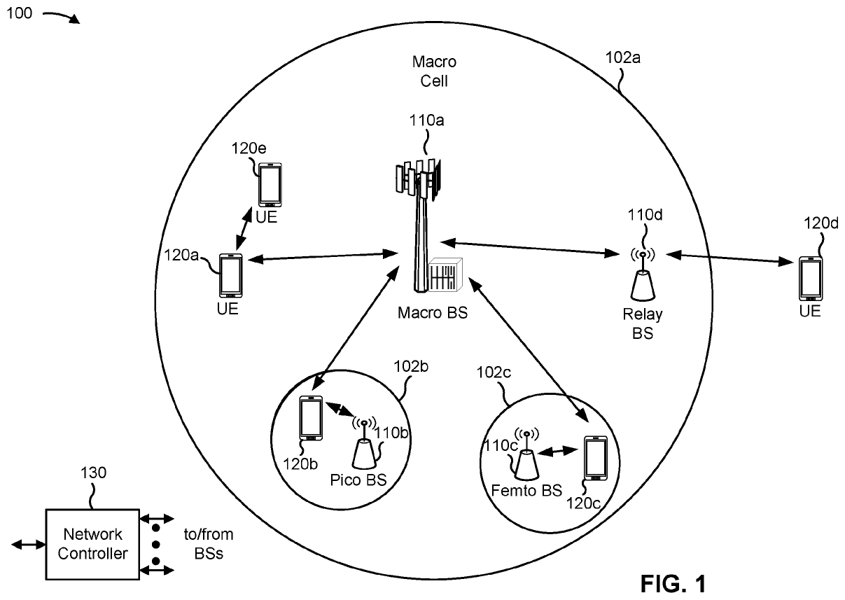

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. ABS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

ABS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

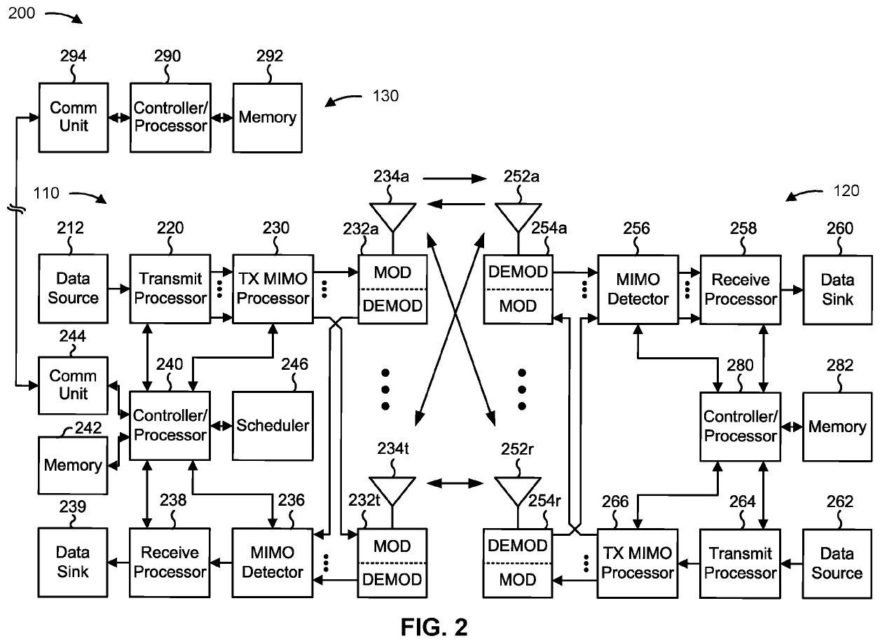

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

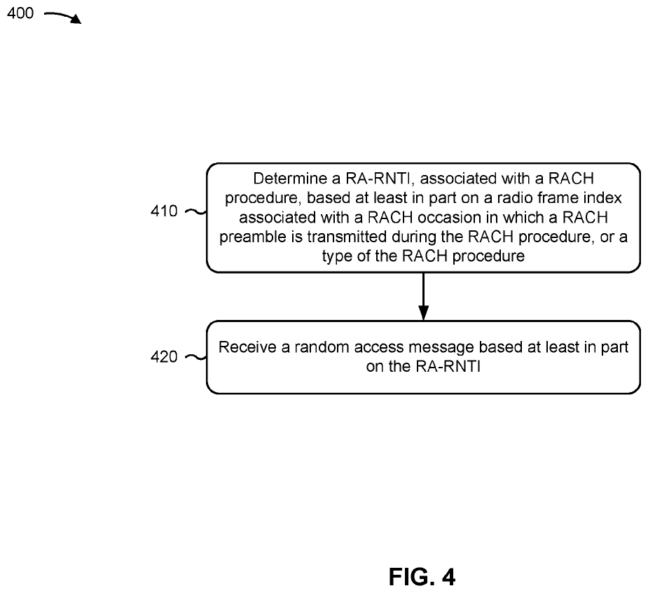

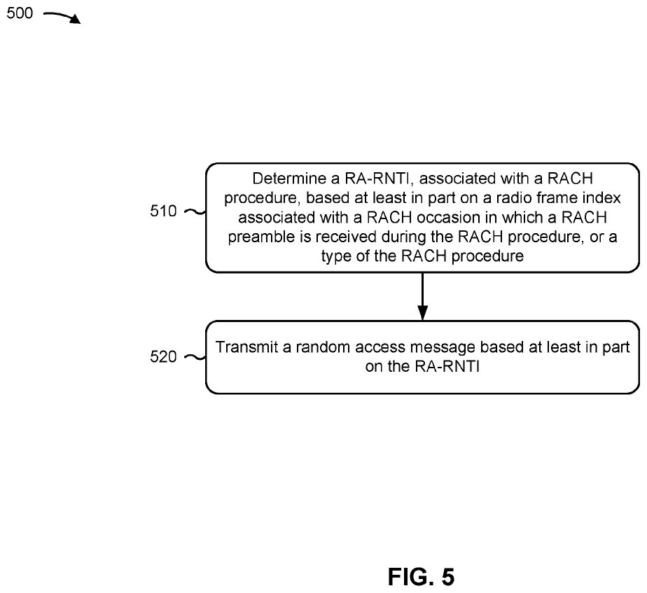

Controller/processor 240 of base station 110, controller/processor 280 of UE 120, and/or any other component(s) of FIG. 2 may perform one or more techniques associated with a RA-RNTI for random access, as described in more detail elsewhere herein. For example, controller/processor 240 of base station 110, controller/processor 280 of UE 120, and/or any other component(s) of FIG. 2 may perform or direct operations of, for example, process 400 of FIG. 4, process 500 of FIG. 5, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed by one or more processors of the base station 110 and/or the UE 120, may perform or direct operations of, for example, process 400 of FIG. 4, process 500 of FIG. 5, and/or other processes as described herein. A scheduler 246 may schedule UEs for data transmission on the downlink and/or uplink.

In some aspects, UE 120 may include means for determining a RA-RNTI, associated with a RACH procedure, based at least in part on: a radio frame index associated with a RACH occasion in which a RACH preamble is transmitted during the RACH procedure, or a type of the RACH procedure; means for receiving a random access message based at least in part on the RA-RNTI; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for determining a RA-RNTI, associated with a RACH procedure, based at least in part on: a radio frame index associated with a RACH occasion in which a RACH preamble is received during the RACH procedure, or a type of the RACH procedure; means for transmitting a random access message based at least in part on the RA-RNTI; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

A random access radio network temporary identifier (RA-RNTI) is a temporary address/identifier that can be used by a UE to receive a random access message associated with a random access channel (RACH) procedure. For example, in a four-step RACH procedure, a UE may use a RA-RNTI to receive a random access response (RAR) associated with the four-step RACH procedure. In the four-step RACH procedure, UEs that transmit a RACH preamble in the same RACH occasion would use the same RA-RNTI. In a two-step RACH procedure, the RA-RNTI may be used for a similar purpose. For example, the UE may use a RA-RNTI to receive msgB (e.g., including different types of RARs) associated with the two-step RACH procedure. The two-step RACH procedure and the four-step RACH procedure can, in some cases, be configured in a shared RACH occasion or in separate RACH occasions.

In general, when the network (e.g., a base station) responds to random access requests sent by UEs, the network multiplexes RARs for UEs with the same RA-RNTI in the same medium access control (MAC) protocol data unit (PDU). The MAC PDU is scheduled by a physical downlink control channel (PDCCH) message scrambled by the RA-RNTI. Therefore, based on the RA-RNTI, a given UE can determine which message contains a response intended for the given UE.

For the four-step RACH procedure, the RA-RNTI is conventionally determined as a value equal to:

1+s_id+14×t_id+14×80×f_id+14×80×8×ul_carrier_id

where s_id is an index of a first OFDM symbol of a physical RACH (PRACH) occasion (e.g., 0≤s_id<14), t_id is an index of a first slot of the PRACH occasion in a system frame (0≤t_id<80), f_id is an index of the PRACH occasion in the frequency domain (0≤f_id<8), and ul_carrier_id is an uplink carrier used for random access preamble transmission (e.g., 0 for a normal uplink carrier, and 1 for a supplemental uplink carrier). The space of the RA-RNTI is typically 16 bits and, therefore, the maximum value of the RA-RNTI is 65536 (e.g., 2¹⁶=65536). However, according to the above formula, the maximum value of a given RA-RNTI is 17920 when a maximum value of each parameter is used.

Generally, a RAR must be sent within a particular of time period after a UE sends a RACH preamble. This time period is referred to as a RAR window. Typically, the RAR window is one radio frame in length (e.g., 10 milliseconds (ms)). As a result, RA-RNTIs repeat after each radio frame. Therefore, if two RACH occasions are in two different radio frames, but have the same symbol, slot, and frequency index, then these two RACH occasions are associated with the same RA-RNTI. However, in some scenarios, the RAR window may need to be longer than one radio frame. For example, for the two-step RACH procedure, because a RACH request also includes a physical uplink shared channel (PUSCH) payload (e.g., including at least an identifier associated with the UE), the network may need additional time to process the request, meaning that it may not be possible for the network to provide a msgB (e.g., including a RAR) within the one radio frame RAR window. As another example, in the context of NR in the unlicensed spectrum (NR-U), the network may need additional time to capture a channel before being able to send a RAR. Therefore, in such cases, the UE may need a comparatively longer RAR window (e.g., to avoid missing a later provided RAR).

However, if a long RAR window (e.g., a RAR window longer than one radio frame) is used, but determination of the RA-RNTI is based on the above formula, there can be ambiguity with respect to the RA-RNTI. For example, if multiple UEs use respective RACH occasions in different radio frames, but have the same symbol, slot, and frequency index, the RA-RNTIs for these multiple UEs would be the same. This ambiguity results in a collision between the two RACH requests and, hence, reduces the RACH capacity of the network.

Another ambiguity arises when a UE using the two-step step RACH procedure and a UE using the four-step RACH procedure transmit RACH preambles in the same RACH occasion. Here, if the above RA-RNTI formula is used for msgB reception, the UE using the four-step RACH procedure can receive and decode msgB intended for the UE using the two-step RACH procedure. Similarly, the UE using the two-step RACH procedure can receive and decode msg2 intended for the UE using the four-step RACH procedure. This can result in ambiguity, for example, if the UE using the four-step RACH procedure decodes the msgB RAR and misunderstands the network's response (e.g., particularly for the RAR corresponding to the successfully received msgA). Therefore, the UE using the four-step RACH procedure should be precluded from receiving msgB of the two-step RACH procedure. Thus, the RA-RNTI should be designed to distinguish between being associated with msg2 reception and msgB reception.

Some aspects described herein provide techniques and apparatuses for an improved RA-RNTI for random access. In some aspects, a wireless communication device (e.g., a UE 120, a base station 110) may determine a RA-RNTI, associated with a RACH procedure, based at least in part on a radio frame index associated with a RACH occasion in which a RACH preamble is communicated during the RACH procedure, and/or based at least in part on a type of the RACH procedure. Various example aspects of this RA-RNTI are provided below.

In some aspects, by taking into account the radio frame index associated with the RACH occasion, the RA-RNTI described herein resolves ambiguity in a scenario when a long RAR window is needed, thereby eliminating collisions between RACH requests and, hence, increasing the RACH capacity of the network. Further, by taking into account the RACH type, the RA-RNTI described herein resolves ambiguity that arises when a UE using the two-step RACH procedure and a UE using the four-step RACH procedure transmit RACH preambles in the same RACH occasion, meaning the RA-RNTI is determined in a manner that allows distinguishing between being associated with the two-step RACH procedure and the four-step RACH procedure.

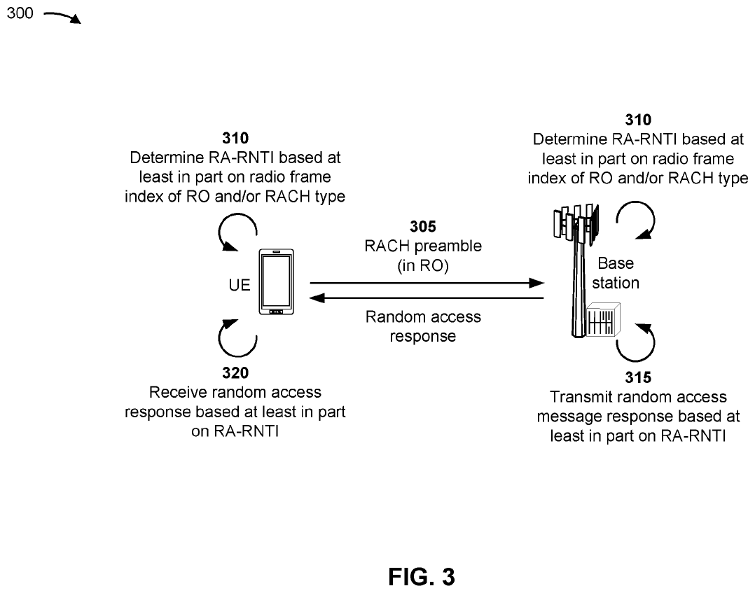

FIG. 3 is a diagram illustrating an example 300 associated with a RA-RNTI for random access, in accordance with various aspects of the present disclosure.

As shown in FIG. 3 by reference number 305 a UE (e.g., UE 120) may transmit a RACH preamble in a RACH occasion (RO). For example, when performing the two-step RACH procedure, the UE may transmit a PRACH preamble along with a PUSCH payload in msgA in the RACH occasion. As another example, when performing the four-step RACH procedure, the UE may transmit a RACH preamble in msg1 in the RACH occasion. As shown, a base station (e.g., base station 110) may receive the RACH preamble transmitted by the UE (e.g., in msgA or in msg1).

As shown by reference number 310, the UE may determine a RA-RNTI associated with the RACH procedure. In some aspects, as shown, the UE may determine the RA-RNTI based at least in part on a radio frame index associated with the RACH occasion in which the RACH preamble was transmitted and/or based at least in part on a type of the RACH procedure (e.g., two-step RACH or four-step RACH). For example, in some aspects, the UE may determine the RA-RNTI based on an index of a first OFDM symbol of a PRACH occasion (e.g., s_id, where 0≤s_id<14), an index of a first slot of the PRACH occasion in a system frame (e.g., t_id, where 0≤t_id<80), an index of the PRACH occasion in the frequency domain (e.g., f_id, where 0≤f_id<8), an uplink carrier used for random access preamble transmission (e.g., ul_carrier_id, where 0 is used for a normal uplink carrier, and 1 is used for a supplemental uplink carrier), the radio frame index associated with the RACH occasion in which the RACH preamble was transmitted, and/or the type of the RACH procedure. In some aspects, the base station may determine the RA-RNTI in a similar manner to that of the UE, as indicated in FIG. 3. For example, in some aspects, the base station may determine the RA-RNTI based on the index of the first OFDM symbol of the PRACH occasion (s_id), the index of the first slot of the PRACH occasion in the system frame (t_id), the index of the PRACH occasion in the frequency domain (f_id), the uplink carrier used for random access preamble transmission (ul_carrier_id), the radio frame index associated with the RACH occasion in which the RACH preamble was received and/or the type of the RACH procedure. Particular examples of determining the RA-RNTI are described below.

In some aspects, the radio frame index may be an index of the radio frame associated with the RACH occasion and may have a value in a range from 0 to 1023. In some aspects, the radio frame index may be used to determine a radio frame indicator value (rf_id) based at least in part on which the RA-RNTI can be determined. In some aspects, the radio frame indicator value may be determined further based at least in part on a number of radio frames (N) spanned by a RAR window associated with the RACH procedure. Various example aspects for determination of the RA-RNTI are provided below.

In a first example aspect, when the RACH procedure is the two-step RACH procedure, the RA-RNTI may be determined based at least in part on a radio frame indicator value equal to one plus a remainder of dividing the radio frame index by the number of radio frames spanned by a random access response window (e.g., rf_id=mod (radio frame index, N)+1). Thus, the radio frame indicator value may be in a range from 1 to a value equal to the number of radio frames spanned by the random access response window when the two-step RACH procedure is being used (e.g., 1≤rf_id≤N when the RACH procedure is the two-step RACH procedure). In this example aspect, when the RACH procedure is the four-step RACH procedure, the RA-RNTI may be determined based at least in part on a radio frame indicator value of 0. That is, when the four-step RACH procedure is being used, the radio frame indicator value may be defined to be 0. In the first example aspect, the RA-RNTI may be determined as a value equal to:

1+s_id+14×t_id+14×80×f_id+14×80×8×ul_carrier_id+14×80×8×2×rf_id

where rf_id is a value in a range from 0 to N, as described above (e.g., 0≤rf_id≤N). Notably, the first example aspect, the radio frame indicator value is used to separate RA-RNTIs for the two-step RACH procedure and RA-RNTIs for the four-step RACH procedure into two RA-RNTI spaces.

In a second example aspect, the RA-RNTI may be determined based at least in part on a radio frame indicator value equal to a remainder of dividing a radio frame index by 2 (e.g., rf_id=mod (radio frame index, 2)). Thus, in this example aspect, the radio frame indicator value may be either 0 (e.g., for radio frames with even numbered radio frame indices) or 1 (e.g., for radio frames with odd numbered indices). In this example aspect, the RA-RNTI may be determined further based at least in part on a type indicator value (ty_id) corresponding to the type of the RACH procedure. For example, the type indicator value may be 1 when the RACH procedure is the two-step RACH procedure and may be 0 when the RACH procedure is the four-step RACH procedure. Thus, in the second example aspect, the RA-RNTI may be determined as a value equal to:

1+s_id+14×t_id+14×80×f_id+14×80×8×ul_carrier_id+14×80×8×2×rf_id+14×80×8×2×2×ty_id

where rf_id is a value in a range from 0 to 1, as described above (e.g., 0≤rf_id<2) and ty_id is 0 for the four-step RACH procedure and 1 for the two-step RACH procedure.

In a third example aspect, when the type of the RACH procedure is a two-step RACH procedure, the RA-RNTI may be determined based at least in part on a radio frame indicator value equal to one plus a remainder of dividing a radio frame index by 2 (e.g., rf_id=mod (radio frame index, 2)+1). Thus, in this example aspect when the RACH procedure is the two-step RACH procedure, the radio frame indicator value may be either 1 (e.g., for radio frames with even numbered radio frame indices) or 2 (e.g., for radio frames with odd numbered indices). In this example aspect, when the RACH procedure is the four-step RACH procedure, the RA-RNTI may be determined based at least in part on a radio frame indicator value of 0. That is, when the four-step RACH procedure is being used, the radio frame indicator value may be defined to be 0. In the third example aspect, the RA-RNTI may be determined as a value equal to:

1+s_id+14×t_id+14×80×f_id+14×80×8×ul_carrier_id+14×80×8×2×rf_id

where rf_id is a value in a range from 0 to 2, as described above (e.g., 0≤rf_id≤2).

In a fourth example aspect, the RA-RNTI may be determined based at least in part on a radio frame indicator value equal to a remainder of dividing a radio frame index by a number of radio frames spanned by a random access response window (e.g., rf_id=mod (radio frame index, N)). Thus, the radio frame indicator value may be in a range from 0 to a value equal to one less than the number of radio frames spanned by the random access response window (e.g., 0≤rf_id≤N−1). In this example aspect, the RA-RNTI may be determined further based at least in part on the type indicator value corresponding to the type of the RACH procedure. For example, the type indicator value may be 1 when the RACH procedure is the two-step RACH procedure and may be 0 when the RACH procedure is the four-step RACH procedure. Thus, in the fourth example aspect, the RA-RNTI may be determined as a value equal to:

1+s_id+14×t_id+14×80×f_id+14×80×8×ul_carrier_id+14×80×8×2×rf_id+14×80×8×2×N×ty_id

where rf_id is a value in a range from 0 to N−1, as described above (e.g., 0≤rf_id≤N−1) and ty_id is 0 for the four-step RACH procedure and 1 for the two-step RACH procedure.

As further shown in FIG. 3, by reference number 315, the base station may transmit a RAR based at least in part on the RA-RNTI. For example, the base station may scramble a PDCCH message, scheduling a MAC PDU including the RAR, using the RA-RNTI, as described above, and may transmit the RAR accordingly. As shown by reference number 320, the UE may receive the RAR based at least in part on the RA-RNTI. For example, based on descrambling the PDCCH using the RA-RNTI, the UE can determine the message that includes the RAR intended for the UE, and may receive the RAR accordingly.

As indicated above, FIG. 3 is provided as an example. Other examples may differ from what is described with respect to FIG. 3.

FIG. 4 is a diagram illustrating an example process 400 performed, for example, by a UE, in accordance with various aspects of the present disclosure. Example process 400 is an example where a UE (e.g., UE 120 and/or the like) performs operations associated with an RA-RNTI for random access.

As shown in FIG. 4, in some aspects, process 400 may include determining a RA-RNTI, associated with a RACH procedure, based at least in part on a radio frame index associated with a RACH occasion in which a RACH preamble is transmitted during the RACH procedure, or a type of the RACH procedure (block 410). For example, the UE (e.g., using receive processor 258, transmit processor 264, controller/processor 280, memory 282, and/or the like) may determine a RA-RNTI, associated with a RACH procedure, based at least in part on a radio frame index associated with a RACH occasion in which a RACH preamble is transmitted during the RACH procedure, or a type of the RACH procedure, as described above.

As further shown in FIG. 4, in some aspects, process 400 may include receiving a random access message based at least in part on the RA-RNTI (block 420). For example, the UE (e.g., using receive processor 258, controller/processor 280, memory 282, and/or the like) may receive a random access message based at least in part on the RA-RNTI, as described above.

Process 400 may include additional aspects, such as any single aspect or any combination of aspects described below and/or in connection with one or more other processes described elsewhere herein.

In a first aspect, when the type of the RACH procedure is a two-step RACH procedure, the RA-RNTI is determined based at least in part on a radio frame indicator value equal to one plus a remainder of dividing the radio frame index by a number of radio frames spanned by a random access response window.

In a second aspect, alone or in combination with the first aspect, the radio frame indicator value is in a range from 1 to a value equal to the number of radio frames spanned by the random access response window.

In a third aspect, alone or in combination with one or more of the first and second aspects, when the type of the RACH procedure is a four-step RACH procedure, the RA-RNTI is determined based at least in part on a radio frame indicator value of 0.

In a fourth aspect, alone or in combination with one or more of the first through third aspects, the RA-RNTI is determined based at least in part on a radio frame indicator value equal to a remainder of dividing a radio frame index by 2.

In a fifth aspect, alone or in combination with one or more of the first through fourth aspects, the radio frame indicator value is either 0 or 1.

In a sixth aspect, alone or in combination with one or more of the first through fifth aspects, the RA-RNTI is determined further based at least in part on a type indicator value corresponding to the type of the RACH procedure.

In a seventh aspect, alone or in combination with one or more of the first through sixth aspects, the type indicator value is 1 when the type of the RACH procedure is a two-step RACH procedure.

In an eighth aspect, alone or in combination with one or more of the first through seventh aspects, the type indicator value is 0 when the type of the RACH procedure is a four-step RACH procedure.

In a ninth aspect, alone or in combination with one or more of the first through eighth aspects, when the type of the RACH procedure is a two-step RACH procedure, the RA-RNTI is determined based at least in part on a radio frame indicator value equal to one plus a remainder of dividing a radio frame index by 2.

In a tenth aspect, alone or in combination with one or more of the first through ninth aspects, the radio frame indicator value is either 1 or 2.

In an eleventh aspect, alone or in combination with one or more of the first through tenth aspects, when the type of the RACH procedure is a four-step RACH procedure, the RA-RNTI is determined based at least in part on a radio frame indicator value of 0.

In a twelfth aspect, alone or in combination with one or more of the first through eleventh aspects, the RA-RNTI is determined based at least in part on a radio frame indicator value equal to a remainder of dividing a radio frame index by a number of radio frames spanned by a random access response window.

In a thirteenth aspect, alone or in combination with one or more of the first through twelfth aspects, the radio frame indicator value is in a range from 0 to a value equal to one less than the number of radio frames spanned by the random access response window.

In a fourteenth aspect, alone or in combination with one or more of the first through thirteenth aspects, the RA-RNTI is determined further based at least in part on a type indicator value corresponding to the type of the RACH procedure.

In a fifteenth aspect, alone or in combination with one or more of the first through fourteenth aspects, the type indicator value is 1 when the type of the RACH procedure is a two-step RACH procedure.

In a sixteenth aspect, alone or in combination with one or more of the first through fifteenth aspects, the type indicator value is 0 when the type of the RACH procedure is a four-step RACH procedure.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, by a base station, in accordance with various aspects of the present disclosure. Example process 500 is an example where a base station (e.g., base station 110 and/or the like) performs operations associated with a RA-RNTI for random access.

As shown in FIG. 5, in some aspects, process 500 may include determining a RA-RNTI, associated with a RACH procedure, based at least in part on a radio frame index associated with a RACH occasion in which a RACH preamble is received during the RACH procedure, or a type of the RACH procedure (block 510). For example, the base station (e.g., using transmit processor 220, receive processor 238, controller/processor 240, memory 242, and/or the like) may determine a RA-RNTI, associated with a RACH procedure, based at least in part on a radio frame index associated with a RACH occasion in which a RACH preamble is received during the RACH procedure, or a type of the RACH procedure, as described above.

As further shown in FIG. 5, in some aspects, process 500 may include transmitting a random access message based at least in part on the RA-RNTI (block 520). For example, the base station (e.g., using transmit processor 220, controller/processor 240, memory 242, and/or the like) may transmit a random access message based at least in part on the RA-RNTI, as described above.

Process 500 may include additional aspects, such as any single aspect or any combination of aspects described below and/or in connection with one or more other processes described elsewhere herein.

In a first aspect, when the type of the RACH procedure is a two-step RACH procedure, the RA-RNTI is determined based at least in part on a radio frame indicator value equal to one plus a remainder of dividing the radio frame index by a number of radio frames spanned by a random access response window.

In a second aspect, alone or in combination with the first aspect, the radio frame indicator value is in a range from 1 to a value equal to the number of radio frames spanned by the random access response window.

In a third aspect, alone or in combination with one or more of the first and second aspects, when the type of the RACH procedure is a four-step RACH procedure, the RA-RNTI is determined based at least in part on a radio frame indicator value of 0.

In a fourth aspect, alone or in combination with one or more of the first through third aspects, the RA-RNTI is determined based at least in part on a radio frame indicator value equal to a remainder of dividing a radio frame index by 2.

In a fifth aspect, alone or in combination with one or more of the first through fourth aspects, the radio frame indicator value is either 0 or 1.

In a sixth aspect, alone or in combination with one or more of the first through fifth aspects, the RA-RNTI is determined further based at least in part on a type indicator value corresponding to the type of the RACH procedure.

In a seventh aspect, alone or in combination with one or more of the first through sixth aspects, the type indicator value is 1 when the type of the RACH procedure is a two-step RACH procedure.

In an eighth aspect, alone or in combination with one or more of the first through seventh aspects, the type indicator value is 0 when the type of the RACH procedure is a four-step RACH procedure.

In a ninth aspect, alone or in combination with one or more of the first through eighth aspects, when the type of the RACH procedure is a two-step RACH procedure, the RA-RNTI is determined based at least in part on a radio frame indicator value equal to one plus a remainder of dividing a radio frame index by 2.

In a tenth aspect, alone or in combination with one or more of the first through ninth aspects, the radio frame indicator value is either 1 or 2.

In an eleventh aspect, alone or in combination with one or more of the first through tenth aspects, when the type of the RACH procedure is a four-step RACH procedure, the RA-RNTI is determined based at least in part on a radio frame indicator value of 0.

In a twelfth aspect, alone or in combination with one or more of the first through eleventh aspects, the RA-RNTI is determined based at least in part on a radio frame indicator value equal to a remainder of dividing a radio frame index by a number of radio frames spanned by a random access response window.

In a thirteenth aspect, alone or in combination with one or more of the first through twelfth aspects, the radio frame indicator value is in a range from 0 to a value equal to one less than the number of radio frames spanned by the random access response window.

In a fourteenth aspect, alone or in combination with one or more of the first through thirteenth aspects, the RA-RNTI is determined further based at least in part on a type indicator value corresponding to the type of the RACH procedure.

In a fifteenth aspect, alone or in combination with one or more of the first through fourteenth aspects, the type indicator value is 1 when the type of the RACH procedure is a two-step RACH procedure.

In a sixteenth aspect, alone or in combination with one or more of the first through fifteenth aspects, the type indicator value is 0 when the type of the RACH procedure is a four-step RACH procedure.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a user equipment (UE), comprising:
determining a random access radio network temporary identifier (RA-RNTI), associated with a random access channel (RACH) procedure, based at least in part on:
a radio frame index associated with a RACH occasion in which a RACH preamble is transmitted during the RACH procedure, or
a type of the RACH procedure; and
receiving a random access message based at least in part on the RA-RNTI.

2. The method of claim 1, wherein, when the type of the RACH procedure is a two-step RACH procedure, the RA-RNTI is determined based at least in part on a radio frame indicator value equal to one plus a remainder of dividing the radio frame index by a number of radio frames spanned by a random access response window.

3. The method of claim 2, wherein the radio frame indicator value is in a range from 1 to a value equal to the number of radio frames spanned by the random access response window.

4. The method of claim 2, wherein, when the type of the RACH procedure is a four-step RACH procedure, the RA-RNTI is determined based at least in part on a radio frame indicator value of 0.

5. The method of claim 1, wherein the RA-RNTI is determined based at least in part on a radio frame indicator value equal to a remainder of dividing a radio frame index by 2.

6. The method of claim 5, wherein the radio frame indicator value is either 0 or 1.

7. The method of claim 5, wherein the RA-RNTI is determined further based at least in part on a type indicator value corresponding to the type of the RACH procedure.

8. The method of claim 7, wherein the type indicator value is 1 when the type of the RACH procedure is a two-step RACH procedure.

9. The method of claim 7, wherein the type indicator value is 0 when the type of the RACH procedure is a four-step RACH procedure.

10. The method of claim 1, wherein, when the type of the RACH procedure is a two-step RACH procedure, the RA-RNTI is determined based at least in part on a radio frame indicator value equal to one plus a remainder of dividing a radio frame index by 2.

11. The method of claim 10, wherein the radio frame indicator value is either 1 or 2.

12. The method of claim 10, wherein, when the type of the RACH procedure is a four-step RACH procedure, the RA-RNTI is determined based at least in part on a radio frame indicator value of 0.

13. The method of claim 1, wherein the RA-RNTI is determined based at least in part on a radio frame indicator value equal to a remainder of dividing a radio frame index by a number of radio frames spanned by a random access response window.

14. The method of claim 13, wherein the radio frame indicator value is in a range from 0 to a value equal to one less than the number of radio frames spanned by the random access response window.

15. The method of claim 13, wherein the RA-RNTI is determined further based at least in part on a type indicator value corresponding to the type of the RACH procedure.

16. The method of claim 15, wherein the type indicator value is 1 when the type of the RACH procedure is a two-step RACH procedure.

17. The method of claim 15, wherein the type indicator value is 0 when the type of the RACH procedure is a four-step RACH procedure.

18. A method of wireless communication performed by a base station, comprising:
determining a random access radio network temporary identifier (RA-RNTI), associated with a random access channel (RACH) procedure, based at least in part on:
a radio frame index associated with a RACH occasion in which a RACH preamble is received during the RACH procedure, or
a type of the RACH procedure; and
transmitting a random access message based at least in part on the RA-RNTI.

19. The method of claim 18, wherein, when the type of the RACH procedure is a two-step RACH procedure, the RA-RNTI is determined based at least in part on a radio frame indicator value equal to one plus a remainder of dividing the radio frame index by a number of radio frames spanned by a random access response window.

20. The method of claim 19, wherein the radio frame indicator value is in a range from 1 to a value equal to the number of radio frames spanned by the random access response window.

21. The method of claim 19, wherein, when the type of the RACH procedure is a four-step RACH procedure, the RA-RNTI is determined based at least in part on a radio frame indicator value of 0.

22. The method of claim 18, wherein the RA-RNTI is determined based at least in part on a radio frame indicator value equal to a remainder of dividing a radio frame index by 2.

23. The method of claim 22, wherein the radio frame indicator value is either 0 or 1.

24. The method of claim 22, wherein the RA-RNTI is determined further based at least in part on a type indicator value corresponding to the type of the RACH procedure.

25. The method of claim 24, wherein the type indicator value is 1 when the type of the RACH procedure is a two-step RACH procedure.

26. The method of claim 24, wherein the type indicator value is 0 when the type of the RACH procedure is a four-step RACH procedure.

27. The method of claim 18, wherein, when the type of the RACH procedure is a two-step RACH procedure, the RA-RNTI is determined based at least in part on a radio frame indicator value equal to one plus a remainder of dividing a radio frame index by 2.

28. The method of claim 27, wherein the radio frame indicator value is either 1 or 2.

29. The method of claim 27, wherein, when the type of the RACH procedure is a four-step RACH procedure, the RA-RNTI is determined based at least in part on a radio frame indicator value of 0.

30. The method of claim 18, wherein the RA-RNTI is determined based at least in part on a radio frame indicator value equal to a remainder of dividing a radio frame index by a number of radio frames spanned by a random access response window.

31. The method of claim 30, wherein the radio frame indicator value is in a range from 0 to a value equal to one less than the number of radio frames spanned by the random access response window.

32. The method of claim 30, wherein the RA-RNTI is determined further based at least in part on a type indicator value corresponding to the type of the RACH procedure.

33-34. (canceled)

35. A user equipment (UE) for wireless communication, comprising:
a memory; and
one or more processors operatively coupled to the memory, the memory and the one or more processors configured to:
determine a random access radio network temporary identifier (RA-RNTI), associated with a random access channel (RACH) procedure, based at least in part on:
a radio frame index associated with a RACH occasion in which a RACH preamble is transmitted during the RACH procedure, or
a type of the RACH procedure; and
receive a random access message based at least in part on the RA-RNTI.

36-37. (canceled)

38. A base station for wireless communication, comprising:
a memory; and
one or more processors operatively coupled to the memory, the memory and the one or more processors configured to:
determine a random access radio network temporary identifier (RA-RNTI), associated with a random access channel (RACH) procedure, based at least in part on:
a radio frame index associated with a RACH occasion in which a RACH preamble is received during the RACH procedure, or
a type of the RACH procedure; and
transmit a random access message based at least in part on the RA-RNTI.

39-40. (canceled)
